(19) United States
(12) Patent Application Publication
(10) Pub. No.: US 2007/0153383 A1
(43) Pub. Date: Jul. 5, 2007

(54) Method for making a wide optical polarizer using extrusion

(76) Inventors: Nicholas Francis Borrelli, Elmira, NY (US); Suresh Thakordas Gulati, Elmira Heights, NY (US); David John McEnroe, Corning, NY (US); Joseph Francis Schroeder, Corning, NY (US)

Correspondence Address: CORNING INCORPORATED, SP-TI-3-1, CORNING, NY, 14831, US

(21) Appl. No.: 11/584,901

(22) Filed: Oct. 23, 2006

Related U.S. Application Data
(60) Provisional application No. 60/755,913, filed on Dec. 30, 2005.

(51) Int. Cl. G02B 5/30

(52) U.S. Cl. 359/492

(57) ABSTRACT

The invention is directed to a method for preparing wide strip optical polarizers by extruding glass and stretching the extruded glass to thereby elongate the polarizing metals or metal salts within the glass. The invention enables one to form a optical polarizers that have a width of 300 mm or larger depending on the size of the die used. The stretching system using two set of rollers as described herein is particularly useful for making larger sizes.

### FIELD OF THE INVENTION

The invention is directed to wide sheet or strip optical polarizers containing silver, copper, or copper-cadmium. In particular, the invention is directed a method using extrusion to produce a strip or bar of glass containing such metals or metal halides and elongating the metal halide or metal(O) particles or crystals by stretching the glass strip or bar such that the width of the bar is retained during the stretching process.

### BACKGROUND OF THE INVENTION

A polarizing effect can be generated in glasses containing silver, copper or copper-cadmium particles. These particles can be precipitated in a borosilicate or boroaluminosilicate glasses having compositions containing suitable amounts of an indicated metal and a halogen other than fluorine. When the particles are stretched and reduced to the metal(0) state they give rise to the such metals give the polarizing effect.

The polarizing effect is generated in these crystal-containing glasses by stretching the glass and then exposing its surface to a reducing atmosphere, typically a hydrogen containing atmosphere. [Alternatively, the reduction can be accomplished by adding a reducing metal, for example, a tin(II) or antimony(III) species such as a non-fluorine halide, a nitrate or other species known in the art to the glass. Additionally, some reduction will occur due to redox reactions that take normally occur during the preparation of boroaluminosilicate or borosilicate glass. However, such method do not allow for as careful control of the reduction step as does the use of a hydrogen-containing reducing atmosphere.] The glass is formed into a stretchable shape, for example, a bar; and the bar is placed under stress at a temperature above the glass annealing temperature. This elongates the glass bar, and thereby elongates and orients the crystals. The shear stress that acts on the particle within the bar is proportional to the viscosity of the glass and the draw speed during elongation. The restoring force that opposes the deformation by the shear force is inversely proportional to the particle radius. Hence, the optimum conditions for producing a desired degree of particle elongation and a resulting polarizing effect at a given wavelength involves a complex balance of a number of properties of the glass and the redrawing process. Once the glass has been elongated, the elongated glass article is then exposed to a reducing atmosphere at a temperature above 120° C., but not higher than 25° C. above the annealing point of the glass. This develops a surface layer in which at least a portion of metal halide crystals present in the glass are reduced to elemental silver or copper or copper/cadmium.

The use of silver halide as a polarizer material capitalizes on two particular properties of the silver halide that are: (1) the liquid particle is very deformable, and (2) it is easier to make larger and controlled particles sizes that other metals. The disadvantages of using silver halide are: (1) that one cannot make polarizers that operate at wavelengths shorter than red (approximately 650 nm) because of the refractive index of the silver halide and (2) that the process requires a hydrogen reduction step. It is possible to stretch metallic silver particles in glass as described by E. H. Land in U.S. Pat. No. 2,319,816 and later by S. D. Stookey and R. J. Araujo in Applied Optics, Vol. 7, No. 5 (1968), pages 777-779. However, the problems encountered are the control of particle size and distribution, especially for visible polarizer application where the aspect ratio of the particle is small, typically 1.5-2 to 1.

The production of polarizing glass, as is described in the patent references provided below, broadly involves the following four steps:

1. Melting a glass batch containing a source of silver, copper or copper-cadmium and a halogen other than fluorine, and forming a glass body or form from a melt;

2. Heat treating the glass body at a temperature above the glass strain point to generate halide crystals having a size in the range of 500-2000 Angstroms (Å);

3. Stressing the halide crystal-containing glass body at a temperature above the glass annealing point to elongate the body and thereby elongate and orient the crystals; and

4. Exposing the elongated body to a reducing atmosphere at a temperature above 250° C. to develop a reduced surface layer on the body that contains metal particles with an aspect ration of at least 2:1.

Glass polarizers, the material compositions and the methods for making the glasses and articles made from the glasses have been described in numerous United States patents. Products and compositions are described in U.S. Pat. Nos. 6,563,639, 6,466,297, 6,775,062, 5,729,381, 5,627,114, 5,625,427, 5,517,356, 5,430,573, 4,125,404 and 2,319,816, and in U.S. Patent Application Publication No. 2005/0128588. Methods for making polarizing glass compositions containing silver, and/or articles made from polarizing or silver-containing glasses have been described in U.S. Pat. Nos. 6,536,236, 6,298,691, 4,479,819, 4,304,584, 4,282,022, 4,125,405, 4,188,214, 4,057,408, 4,017,316, and 3,653,863. Glass articles that are polarizing at infrared wavelengths have been described in U.S. Pat. Nos. 5,430,573, 5,332,819, 5,300,465, 5,281,562, 5,275,979, 5,045,509, 4,792,535, and 4,479,819; and in non-U.S. patents or patent application publications JP 5-208844 and EP 0 719 741. The Japanese patent publications describe a copper-based polarizing glass instead of a silver-based polarizing glass.

The equipment and method used to stretch glass to form polarizers has been described in the art; for example, in U.S. Pat. No. 4,479,819 to Borrelli et al. (assigned to Corning Incorporated) and other polarizing glass patents or patent applications of Corning Incorporated. Examples of a silver-containing glass bar before and after stretching (drawing) into polarizer are shown in FIG. 1. The top of the article on the left side and the bottom of the article on the right side of FIG. 1 illustrate a bar before it has been stretched into a polarizer. The center article of FIG. 1 illustrates the polarizer after it was been stretched. The stretching was carried out using a commercially obtained drawing apparatus as illustrated in FIG. 2 and further described herein. Polarizer made using the equipment and techniques as illustrated in FIGS. 1 and 2 produce polarizers that are considerably narrower than the initial width of the form that was used to produce the polarizer. While these narrower widths are suitable for many applications, for some application it is desirable to have much wider polarizers that cannot be made using methods known in the art. Accordingly, it is an object of this invention to provide a method for forming an optical polarizer that retains the width of initial shape that was used to form the polarizer or in which width reduction of the initial shape is minimized during the stretching process.

### SUMMARY OF THE INVENTION

In one embodiment the invention is directed to a method for making wide strip glass optical polarizers suitable for polarizing light in the visible, infrared and ultraviolet regions, said method stretching the polarizing crystals within the glass in a manner such that the width of the glass form is either retained or any reduction in the width of the glass is minimized. In preferred embodiments the width reduction is 20% or less. The method of the invention can be used with glasses containing silver, copper and copper-cadmium.

In another embodiment the invention is directed to a method of making glass optical polarizers, said method comprising the steps of: preparing a glass melt batch containing a polarizing metal as the salt or metal(0) species and casting melt into boule; placing the boule or a form made from the boule into an extruder; heating the boule to a temperature at which the glass has a viscosity of at least 10⁷ poise; extruding the glass through a die and grabbing the end of the glass extruded from the die; stretching the extruded glass into a ribbon having the width or substantially the width of the glass as it was extruded from the die; treating the glass ribbon containing a polarizing metal salt in a reducing atmosphere at temperature below the softening point of the glass for a time in the range of 4-40 hours to produce a polarizing metal(0) layer in the glass; polishing the ribbon; and cutting the ribbon to the desired size to thereby form an optical polarizer.

In a further embodiment the invention is directed to a method for making a silver-containing visible light glass polarizer, the method consisting of the steps of melting a glass batch containing a source of silver and a halogen other than fluorine, and forming a body from a melt; heat treating the glass body at a temperature above the glass strain point to generate halide crystals having a size in the range of 500-2000 Angstroms (Å); stressing the crystal-containing glass body at a temperature above the glass annealing point to elongate the body and thereby elongate and orient the crystals; and exposing the elongated body to a reducing atmosphere at a temperature above 250° C. to develop a reduced surface layer on the body that contains metal particles with an aspect ration of at least 2:1. The stressing is carried out at a temperature above the annealing point of the glass using two set of rollers, the glass being fed into a first set of rollers operating a first rotational speed and after passing through the first set of rollers the glass is picked up by a second set of rollers operating at a second rotational speed that is greater than the first rotational speed. The difference in the rotational speeds of the two sets of rollers serves to elongate the glass and stretch the particles therein.

### BRIEF DESCRIPTION OF THE DRAWINGS

FIG. 1A illustrates a glass bar that has been stretched according to prior art methods and shown an unstretched top and bottom part of the bar and the stretched middle part of the bar that forms the polarizing glass.

FIG. 1B is a side-by-side comparison of a wide polarizing strip according to the invention (upper strip) versus a narrow strip from a glass stretched according to the prior art (lower strip).

FIG. 2 illustrates the furnace, load cell and glass bar suspended in the furnace that are used to form the polarizer illustrated in FIG. 1.

FIG. 3 illustrates the mathematics and the “conservation of volume” of the drawing (stretching) process.

FIG. 4 illustrates an embodiment of the invention in which sets of rollers operating at different speeds are used to stretch a glass bar while minimizing the width reduction of the bar.

FIG. 5 illustrates an embodiment of the invention in which in place of one set of rollers an extruder is used to extrude and deliver a glass bar to a set of rollers that that rotates at a speed sufficient to reduce the thickness of the glass by stretching of the glass and the particles therein to produce the polarizing effect while maintaining or substantially maintaining the width of the glass.

FIG. 6 illustrates an embodiment of the invention in which glass is stretched directly from an extruded using a “gripper” to grip and pull one end of the glass to thereby elongate the particles within the glass.

FIG. 7 is an illustration of the extrusion set-up and a glass bar or ribbon exiting the die.

FIG. 8 is a picture of showing the main components of the extruder system.

FIG. 9 is a spectrum obtained using a first polarizing glass produced using the extrusion/draw system of the invention.

FIG. 10 is a spectrum obtained using a second polarizing glass produced using the extrusion/draw system of the invention.

### DETAILED DESCRIPTION OF THE INVENTION

As used herein the terms “glass bar” and “bar” mean any glass form or glass article that can be stretched to thereby elongate particles contained therein to thereby form a polarizer capable of polarizing light wavelengths within the visible, infrared and ultraviolet regions. In addition, herein a silver halide containing glass is used for exemplary purposes without limitation of the invention to make wide strip polarizers according to the invention. Copper and copper-cadmium containing polarizers can be made in a similar manner as silver-containing polarizers.

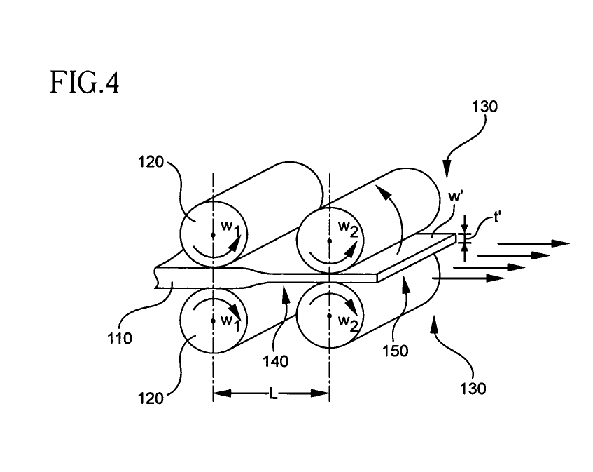

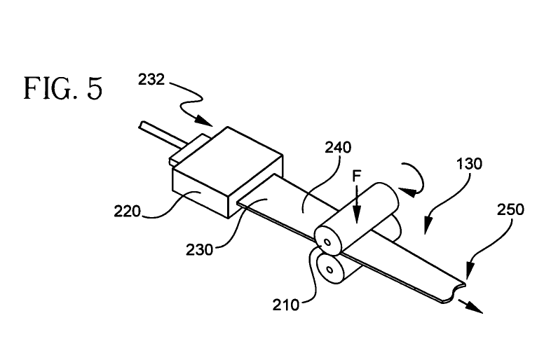

In general, the invention is directed to a method for making a glass polarizer, the method consisting of the steps of melting a glass batch containing a source of polarizing material (for example, a silver or copper salt), and forming a body from a melt; heat treating the glass body at a temperature above the glass strain point to generate crystals having a size in the range of 500-2000 Angstroms (Å); stressing the crystal-containing glass body at a temperature above the glass annealing point to elongate the body and thereby elongate and orient the crystals; and exposing the elongated body to a reducing atmosphere at a temperature above 250° C. to develop a reduced surface layer on the body that contains metal particles with an aspect ratio of at least 2:1. In accordance with the invention the stressing is carried out using the embodiments illustrated in FIGS. 4-6. For example, one can use the method illustrated in FIG. 4 where a glass at a temperature above its annealing is passed through two sets of rollers, the glass being fed into a first set of rollers operating a first rotational speed and after passing through the first set of rollers the glass is picked up by a second set of rollers operating at a second rotational speed that is greater than the first rotational speed. Alternatively, one can use the embodiment illustrated in FIG. 5, extruding the glass through a die at a temperature above its annealing point and passing the glass through a set of rollers operating at a rotational speed sufficient to pull and to elongate the glass and the particles therein. After the glass and particles therein have been elongated as described in either embodiment, the elongated particles can then be reduced to form polarizing particles, for example, silver(0) or copper(0) particles, if reduction has not already been carried out by redox reactions due to the addition of a reducing materials such as tin(II) or antimony(III) to the glass formulation, or by such other redox reactions that may occur in the glass that would reduce, for example, a silver or copper salt to silver(0) or copper(0).

In one embodiment the invention is directed to a method for making a silver-containing visible light glass polarizer, the method consisting of the steps:

1. Melting a glass batch containing a source of silver and a halogen other than fluorine, and forming a body from a melt;

2. Heat treating the glass body at a temperature above the glass strain point to generate halide crystals having a size in the range of 500-2000 Angstroms (Å);

3. Stressing the crystal-containing glass body at a temperature above the glass annealing point to elongate the body and thereby elongate and orient the crystals; and

4. Exposing the elongated body to a reducing atmosphere at a temperature above 250° C. to develop a reduced surface layer on the body that contains metal particles with an aspect ratio of at least 2:1;

wherein the stressing carried out at a temperature above the annealing point of the glass using two set of rollers, the glass being fed into a first set of rollers operating a first rotational speed and after passing through the first set of rollers the glass is picked up by a second set of rollers operating at a second rotational speed that is greater than the first rotational speed. The difference in the rotational speeds of the two sets of rollers serves to generate sufficient stress to elongate the glass and stretch the particles therein.

The method of the invention can be used with any suitable borosilicate or aluminoborosilicate glass composition that is suitable for making optical components or articles. Examples of suitable compositions can be found in the patents and patent applications cited above in the Background section of this specification. By way of example, without limiting the invention to this particular composition, one can use the following exemplary composition shown, without inclusion of the chloride content, in Table 1 that contains 0.05-1.0 wt/% Ag. Chloride is present at least in an amount sufficient for all the silver to exist as silver chloride.

TABLE 1
(wt. %)

| | |
|---|---|
| SiO₂ | 20–60 |
| Al₂O₃ | 12–20 |
| B₂O₃ | 10–25 |
| Ag | 0.05–1.0 |

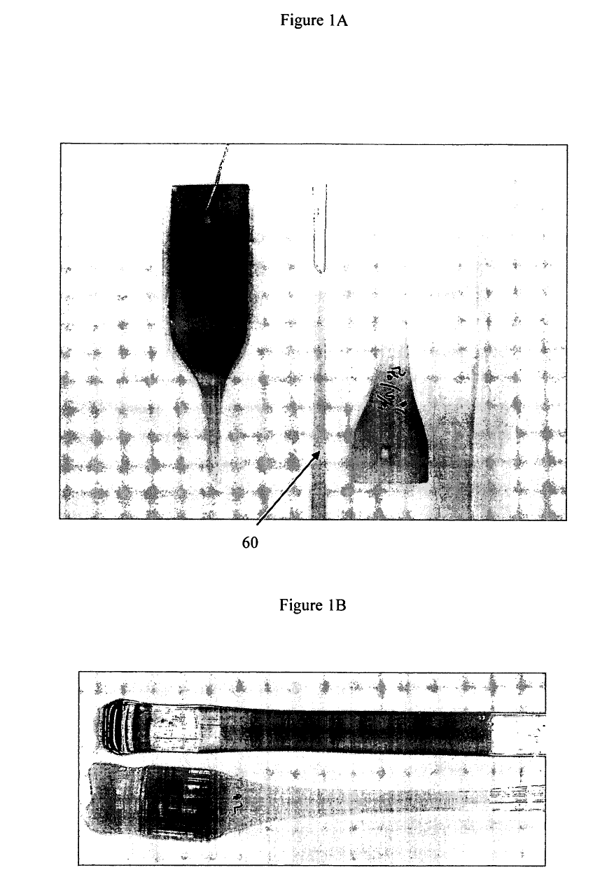

In making the glass composition the Si, Al and B materials can be added as oxides (though other forms of these materials known in the art to be suitable for making glass can also be used) and Ag is added as a non-fluoride silver salt. Examples, without limitation, of such silver salts include silver chloride, silver bromide, silver iodide, silver nitrate, silver nitrite, silver carbonate and silver oxide, or a mixture of any of the foregoing. Silver nitrate, silver nitrite, silver chloride and silver oxide, including mixtures thereof, are the preferred silver salts. (Similar salts can be used for the copper and cadmium containing polarizers.) The amount of silver salt(s) added is sufficient to produce glass containing 0.05-1.0 wt. % silver calculated as silver(0). When a non-halide silver salt is used, the halogen source can be one of the other materials comprising the glass or halogen can be added in the form of an alkali or alkaline earth metal halide such as NaCl, CaCl₂, NaBr, and so forth. Substances such as aluminum chlorhydrate can also be used as a source of halide ion, in this case chloride. For the example given below, SiO₂, Al₂O₃, B₂O₃ and sufficient silver chloride to yield a silver content (as Ag⁰) in the range of 0.05-1.0 wt. % were melted in a quartz crucible at approximately 1350° C. for approximately 16 hours to produce a clear, slightly yellow glass (see FIG. 1, left side). The slightly yellow color of the glass indicates that substantially all of the silver is dissolved in the glass composition as the silver(+1) ion. The glass also fluoresces under ultraviolet light indicating that at least some of the silver is present as reduced silver, that is, Ag⁰.

In one embodiment, once the melt has been completed, the glass can then be shaped prior to drawing (stretching). For example, the molten glass can be poured into a mold and cooled [or a glass boule is formed from a melt, cooled and then cut into the desired shape for example, a bar) for drawing]), and then Blanchard ground into bars, for example bars that are approximately 25-100 cm long, 7.5-10 cm wide and 0.5-1.5 cm thick. To allow higher draw forces on the glass, before drawing an optional etching step or an optional thermal treatment step, or both, can be used to remove and/or heal surface and subsurface defects; for example, but not limited to, subsurface defects that may be introduced during the grinding process. When a glass surface is mechanically removed (for example, by grinding), many surface and/or subsurface fractures or flaws can either result or become exposed. Under an applied stress these fractures or flaws can propagate into the glass body causing the glass to fracture. By chemically etching and/or thermally treating the glass surface, the flaws are healed by rounding out the fracture (flaw) surface or by closing it using a thermal treatment. Thermal treatments are generally carried out at a temperature near (within 25-50° C.) the softening point of the glass composition. As an example of etching, prior to drawing (stretching) the glass, the glass bar is immersed in a dilute hydrofluoric acid solution for a period of time sufficient to remove a portion of the surface having contamination and/or flaws. If deemed necessary, visual inspection, with or without the use of magnification, can be used to determine when the process is completed.

In another embodiment, once the melt has been completed the glass boule, or one or a plurality segments thereof, can be loaded into a hot glass extruder and extruded with stretching as described below.

The basic idea in the making of polarizing glass is to redraw or stretch the glass that contains a thermally developed silver halide particle phase. The stretching of the glass is done at a viscosity sufficiently high to develop the shear stress necessary to allow the silver halide particle to elongate. The shear stress is essentially equal to the load divided by the cross-sectional area as shown in Equation I.

$$τ \approx \frac{F}{A} = η \frac{d ɛ}{d t} \qquad Eq . I$$

In Equation I, τ is the shear stress acting on the crystal from the flowing glass, F is the load, A is the cross-sectional area of the bar, η is the viscosity, and ε is the strain. The strain rate is essentially the velocity at which the strip is moving. The dimensional change of the bar will also be proportional to this quantity. However, it is through the shape change of the silver halide particle that ultimately leads to the dichroism, or polarizing property. The extent of the elongation of the particle depends on the shear stress itself, which in turn is proportional to the viscosity difference between the particle and the glass. The aspect ratio of the particle ultimately determines the wavelength of the maximum contrast

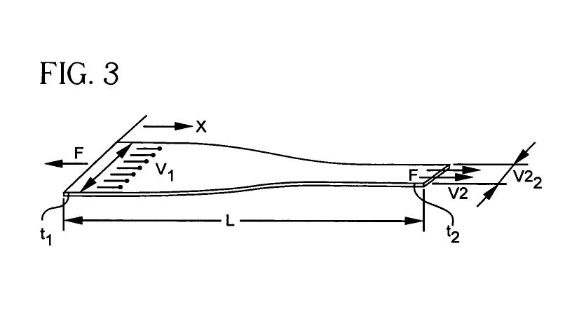

The redraw process requires that the width and/or thickness of the original treated glass bar be reduced since the volume is conserved. That is, the following is true: “The velocity times the cross-sectional area is a constant.” Referring to FIG. 3, at any two points along the path Equation II must be satisfied.

V₁w₁t₁=V₂w₂t₂ Eq. II

Typically, in the commercial hot redraw processes used to make polarizing glasses, the reduction ratio, w₂/w₁, that results when sufficient elongation of the particle phase is produced is on the order of 4-5 to 1. This is the illustrated in shown in FIGS. 1A, 2 and 3. However, if one wants to make wide polarizing strip, for example, a strip having a width of 300 mm, the initial width dimension of the bar that one would have to use to obtain a final width of 300 mm is impractically large, being on the order of 1200-1500 mm. Additionally, the situation is worsened due to the problem of maintaining a constant temperature (viscosity) across such a wide bar. The method of the invention can produce polarizers wider than 300 mm depending on the size of the die through which the glass passes; particularly when the two roller stretching system as described herein is used.

Using the geometry shown in FIG. 4, it can be determined that the width reduction is related to the thickness reduction by Equation III.

$$\frac{{w}_{2}}{{w}_{1}} = \frac{1}{1 + \frac{τ L}{η {V}_{1}}} \frac{{t}_{1}}{{t}_{2}} \qquad Eq . III$$

where τ is the shear rate which is related to the applied pressure (F/wt), η is the viscosity, L is the distance between the rollers, and V₁ is the feed velocity. What is necessary to produce a wide strip optical polarizer is to operate at a sufficiently high viscosity where the shear rate is high enough to produce elongation of the halide droplet and where the smallest change in the width will occur. We have computed the situation represented by Equation III for a few possible conditions with the assumption that the viscosity is 10⁷ poise and the force on the second set of rollers is 270 pounds per 10 inch (approximately 25.4 cm) length. The parameter is the relative velocity ratio of the two rollers which is a measure of the strain rate. We determined that to assure that the width reduction is less than 20% requires that the thickness reduction be >3. If a viscosity of 10⁶ poises had been selected instead of 10⁷ poise, the velocity ratio parameter would be ten times greater. Experimentally we have determined that a practical combination of quantities is realizable as is evidenced by the wide strip polarizer shown in FIG. 1B. A force of 270 lbs/inch was applied to a fluid with a viscosity of 10⁷ poises and a linear velocity of five times the feed rate was maintained.

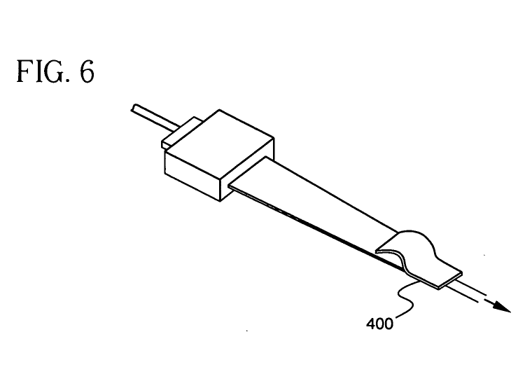

Additional embodiments of the above process involve basically the same physics. The first is shown in FIG. 5 in which the first set of rollers described above have been replaced by an extruder 200. Extruder 200 has a heated die 230 with an orifice 240. A glass feed is placed in die 230, heated to a viscosity of 107 poise or higher and forced through orifice 240 using plunger 232 to form sheet 210. Sheet 210 is delivered to rollers 130 which are operating at a rotational rate. The advantage here is that one can extrude wider strip to start with, and the feed can be cullet rather than a bar. The initial velocity V₁ is then the rate the glass is being extruded, and otherwise the analysis is the same as the case described above. A second embodiment is illustrated in FIG. 6 in which a “gripper” is used in place of the second set of rollers.

### Prior Art Stretching

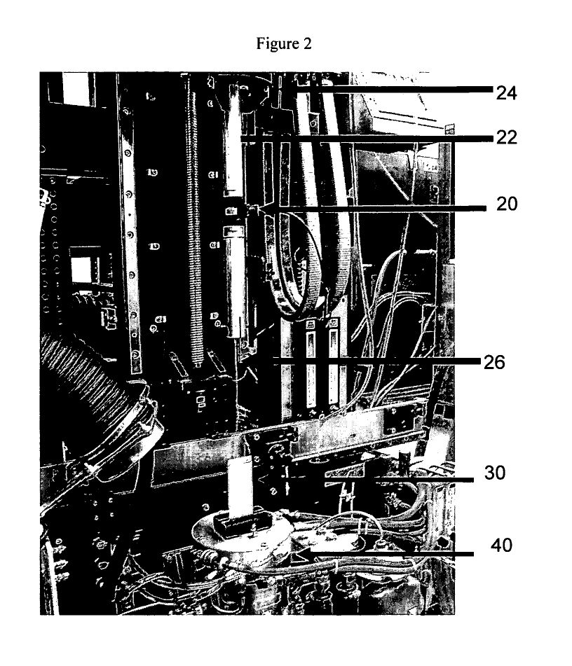

In the prior art process of making polarizers a draw tower (purchased from Heathway Ltd, now Herbert Arnold GmbH & Co. KG, Weilburg, Germany) as shown in FIG. 2 was used to draw a glass bar. This type of draw system resulted in a narrowing of the bar as illustrated in FIG. 1, and is comprised of a downfeed system, furnace 40 and pulling tractors (not illustrated) that were used to stretch-down glass bars 30 under high tension. A glass composition was melted in a crucible then poured into a rough bar form using a mold. The bars were then either machined finished or used as-poured in the drawing. For example, the bars 30 were approximately 5 cm wide by 10 to 100 cm long, and were of varying thicknesses in the range of 0.6 to 1.5 cm. Holes were drilled on each end of the bars (see FIG. 1); one hole being used to hang the bar from a metal cylinder 22 on the downfeed system and the other hole was used to grasp the bar to start the drawing process. As illustrated in FIG. 2, a load cell 20 was attached to a metal cylinder 22 that was held in the place in the downfeed chuck 24 and the other end of the load cell 20 supported the glass bar 30. The furnace 40 was a graphite resistance furnace that can span a wide temperature range. The furnace 40 was controlled using a pyrometer and programmable controller. The glass bar 30 was suspended in the furnace 40 by a wire 26 connected to the metal cylinder 22 plus load cell 20 as shown in FIG. 2.

After placing bar in the furnace, the furnace temperature was raised to a temperature at which the glass was soft enough to enable pull-down. For the exemplary composition given above, a temperature in the range of 650-725° C. was used for drawing (stretching) the glass. Once the glass bar 30 was initially pulled down, the downfeed which lowers the glass bar 30 into the furnace at a controlled rate was started. The bars were drawn down to form a ribbon 60 (see FIG. 2) in which the width and the thickness of the glass was reduced as the glass was being elongated (stretched). After drawing and cooling, the ribbon 60 was cut into the proper sizes for their intended applications; for example, optical polarizers in telecommunications equipment.

### Roller-Only Stretching According to the Invention

In one embodiment according to the invention, a optical polarizer is formed in which the width of the polarizer after stretching is the same or substantially the same as the bar used in the stretching process. That is, width reduction is minimized. Referring to FIG. 4, the stressing carried out at a temperature above the annealing point of the glass using two sets of rollers. A glass 110 is fed into a first set of rollers 120 operating a first rotational speed ω₁. After passing through the first set of rollers 120 the glass 120 is picked up by a second set of rollers 130 operating at a second rotational speed ω₂ that is greater than the first rotational speed ω₁. Since the glass is between the two sets of rollers operating at different rotational speeds, it is stretched at 140 as illustrated. Finally, the glass emerges from rollers 130 is in a wide, stretched form as illustrated at 150 that has the same or substantially the same width as glass 110 that was fed into rollers 120. The glass emerging at 150 can cut and subjected to a reduction step, for example, hydrogen reduction, to form a glass optical polarizer. Alternatively, the strip 150 emerging from rollers 130 can be fed into a reduction furnace and reduced using hydrogen or a hydrogen/inert gas mixture.

In accordance with the invention, a optical polarizer is formed in which the width of the polarizer after stretching is the same or substantially the same as the bar used in the stretching process. That is, width reduction is minimized. FIG. 4 illustrates an embodiment in simplified form. In FIG. 4 the stressing carried out at a temperature above the annealing point of the glass using two set of rollers, the glass being fed into a first set of rollers operating a first rotational speed and after passing through the first set of rollers the glass is picked up by a second set of rollers operating at a second rotational speed that is greater than the first rotational speed.

### Extrusion and Stretching

The extrusion process has been well established for metals, ceramics and plastics, but with glass the process has not widely been used or developed. Extrusion of glasses can be achieved at higher viscosities greater than 10⁸ poise, which can diminish crystallization effects and improve non-circular shaped products by suppressing surface tension effects. Extrusion allows the forming of glasses that have a steep viscosity curves, low softening points, liquidus temperatures in the forming range or small volume of product.

The extrusion process can also be a viable tool to fabricate bars or ribbon of glass by extrusion through a rectangular die. A cylindrical glass form can be loaded into the extruder and then extruded out as a bar or ribbon of glass. The added benefit of the extruder is that the glass exiting out of the die can be attenuated down into a smaller size by a draw-down system. If the viscosity of the exiting glass is controlled to a high viscosity then stress can be applied to stretch the glass, and therefore stretch the silver or silver halide component in the glass. Stretching the silver component gives rise to creating a polarizing effect in the glass.

In accordance with the present invention, the extrusion process can be used to fabricate and stretch bars or ribbon of glass by extrusion through a rectangular die and the application of a stretching force. For example, a cylindrical glass form can be loaded into the extruder and then extruded as a bar or ribbon of glass. The glass exiting out of the die can be immediately be attenuated down into a smaller size by a draw-down system. If the viscosity of the exiting glass is controlled to a high viscosity then stress can be applied to stretch the glass and therefore stretch a silver(0) or silver halide component in the glass. Stretching the silver component gives rise to creating a polarizing affect in the glass. The systems as taught herein can also be used with copper and copper-cadmium containing glasses

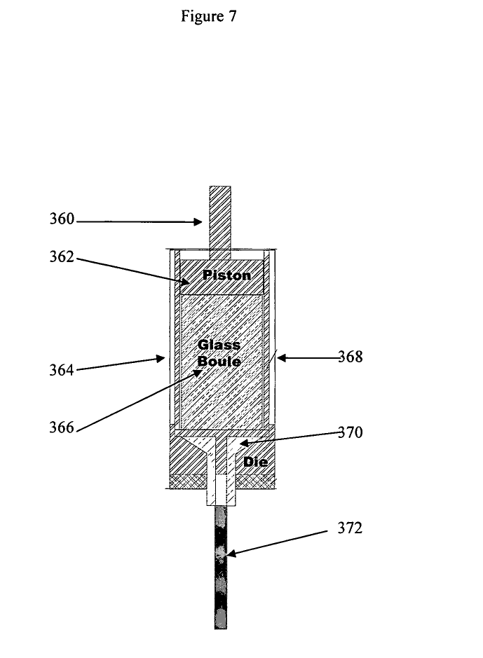

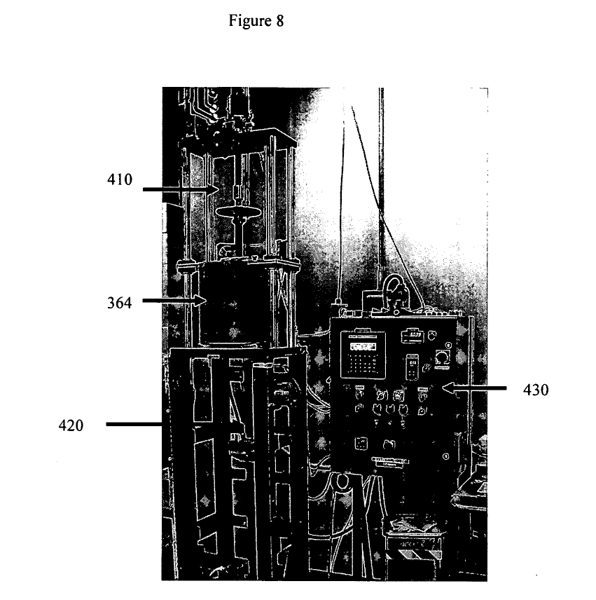

The extrusion process is accomplished using a commercial 5-ton hot glass extruder (Advantek Engineering, Brimfield, Mass.). The extruder, schematically illustrated in FIG. 7 is comprised of a furnace 364, downfeed system 410 (FIG. 8), control cabinet 430 and a draw-down system 420 (FIG. 8) placed on a metal support structure. The furnace 364 is resistance wire heated with an upper use temperature of 1200° C. A piston 362 with attached rod 360, barrel or sleeve 368 and die 370 made from RA330 metal alloy are components that sit inside the furnace and are used to press the glass 366 inside the sleeve through the die 370. The piston is attached to the downfeed system as exemplified by rod 360 and allows control of the load being applied to the glass during the extrusion process. The draw-down system, not illustrated, is a four-foot long motorized slide has a three-jaw chuck 400 (see FIG. 6) attached to hold the glass piece 372 being extruded. The draw-down system has a variable speed control which enables the glass piece 366 to be attenuated down as it exits the die 370 or just to hold the glass piece in place without any attenuation.

By controlling the temperature which dictates the glass viscosity, the downfeed system-piston and the draw-down parameters allows control of the extrusion rate and load. A load cell is positioned on the downfeed shaft connected to the piston to measure the amount of force being exerted on the glass above the die. FIG. 8 shows the extruder along with the major components described above. A plexi-glass enclosure was placed around the bottom of the extruder to limit air flow around the extruder that could possibly thermal-shock the glass as it exits out the extruder.

Referring to FIGS. 7 and 8, the extruder was loaded with either glass pucks or a glass boule that was placed inside the extruder's metal barrel. The glass pucks or boule must be slightly less than the internal dimensions of the barrel so that they fit. After the barrel was loaded it was placed on top of the die. The die has positioning holes in the bottom which seats on a metal support with alignment pins. Refractory rings were placed between the metal support and the die to provide thermal insulation to the die. The furnace was lowered into place and rested on the upper rim of the barrel which holds the barrel in place on the die. The furnace was then disconnected from the downfeed system and the downfeed was raised up. The piston was then placed on top of the glass with a thin metal plate placed between the glass and piston. The downfeed was lowered to the piston and connected to the downfeed unit. The piston was raised approximate a half-inch to keep the glass from being crushed when heated due to expansion of the metal and glass.

The furnace was programmed with a slow ramp rate and a hold at elevated temperature to insure thermal equilibrium is present (usually done overnight, approximately 12-16 hours or longer) overnight. Once equilibrium is achieved, a series of compression steps were carried out by lowering the piston down until a load was recorded on the load cell. The pressure was allowed to drop off and then several additional compressions were done to ensure the glass had filled out into the barrel and die. Once the pressure did drop off or dropped off at a slow rate the system was ready to start extruding.

To be able to attach the extruded piece to the draw-down chuck, either a bait rod of the same glass as being extruded was placed in the chuck and positioned just under the die so it would adhere to the extruded piece or the extruded piece was allowed freely move down until the chuck could be attached. The downfeed rate was set in the controller to start pushing the glass through the die and a draw-down rate was also set. The rates were determined by the load reading and the final geometry of the extruded piece. Although when extruding the load can have a broad range, it was observed that a load of approximately 2500 pounds produced satisfactory results. If the load continued to climb once the extrusion was begun, either the temperature or feed rate was adjusted because the unit has a maximum load setting of 4500 pounds and if the load exceeds this value the feed will shut down. Conversely, if the load drops off during the extrusion, either the temperature can be lowered or feed rate increased to keep the load at higher values.

When the extrusion parameters were set the extrusion was allowed to continue until the draw-down unit reached the lower limit of travel. Pieces 3-3.5 feet in length were extruded. If glass was still present in the furnace (the height of piston signifies this) the glass piece can be scribed and broken off and the drawdown unit was raised to attach to the broken end and the run can be continued. When the load force starts to raise dramatically this signifies the end of the run and that there is no more glass in the barrel.

To further illustrate the extrusion method of the invention, 3-4 round pucks of glass were loaded into the extruder barrel. After loading the pucks, placing the barrel in place and carrying out the other operations as described above, the furnace was programmed to heat to 800° C. at a rate of 0.5° C./minute. The heating and attainment of thermal equilibrium are performed overnight (approximately 12-16 hours). Compressions were started as described above and were continued until glass started to exit out the die, and a load was maintained. A grabber was designed to fit into the chuck and grab onto the ribbon. It has cantilever arms so when the grabber is pulled down it closes tightly onto the glass piece. Once the glass ribbon extruded down far enough below the die it was attached to the grabber and the draw-down unit started. The extrusion parameters used through the run were:

Start up: temperature was approximately 800° C.; downfeed approximately 0.3 mm/min.; draw rate approximately 18 mm/min.; and load cell approximately 1730 pounds.

Increased feed to 0.3 mm/min., lowered temperature to 790° C. load increased to 1885 pounds and increased draw to 25 mm/min.

Increased draw to 40 mm/min. to apply more tension on the piece, load at 2150 pounds but was dropping slightly.

Changed feed to 0.4 mm/min., scribed piece and restarted draw.

After restart—Temperature @785° C., Feed @0.35 mm/min., Draw rate 50 mm/min. and load at 2585 pounds.

End of run—Temperature @780° C., Feed at 0.4 mm/min., Draw rate 75 mm/min. and load at 2220 pounds.

At the higher draw rate (>50 mm/min.) the ribbon was attenuating down to about a 2 inch wide strip and good tension was being applied. It was difficult to restart the run at temperatures below 800° C.

The foregoing experimental run produced a wide polarizer illustrated in FIG. 1B. Once the glass has been elongated, the elongated glass article is then exposed to a reducing atmosphere at a temperature above 120° C., but not higher than 25° C. above the annealing point of the glass. This develops a surface layer in which at least a portion of metal halide crystals present in the glass are reduced to elemental silver or copper.

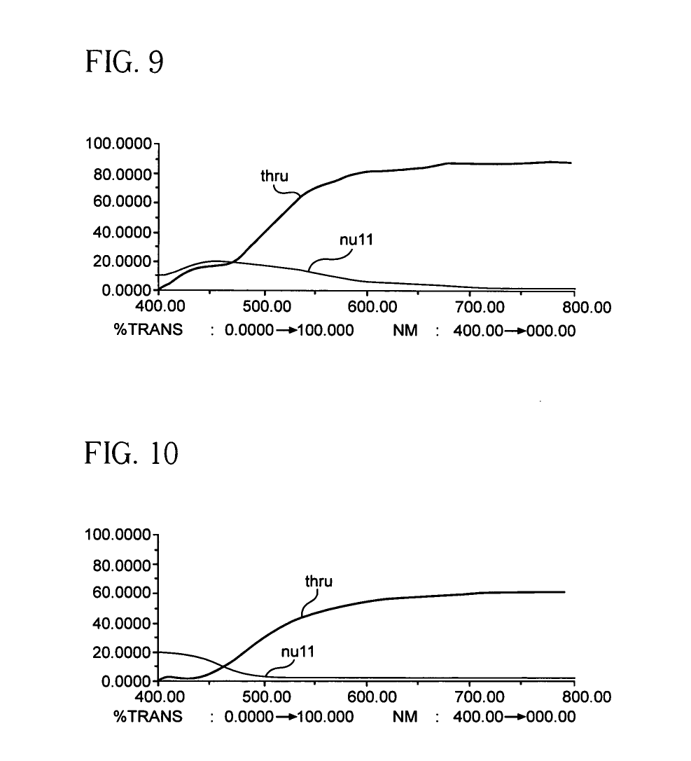

FIG. 9 and 10 were obtained using polarizing glass produced by the extrusion process described above. The Figures clearly indicate that extrusion and stretching the glass under tension stretches the silver halide component and results in a wide strip or ribbon of polarizing glass

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A method of making a glass optical polarizers, said method comprising the steps of:
preparing a glass melt batch containing a polarizing metal as the salt or metal(0) species and casting melt into boule;
placing the boule or a form made from the boule into an extruder;
heating the boule to a temperature at which the glass has a viscosity of at least 10⁷ poise;
extruding the glass through a heated die and grabbing the end of the glass extruded from the die;
stretching the extruded glass into a ribbon having the width or substantially the width of the glass as it was extruded from the die;
treating the glass ribbon containing the polarizing metal salt in a reducing atmosphere at temperature below the softening point of the glass for a time in the range of 4-40 hours to produce a polarizing metal(0) layer in the glass; and
polishing the ribbon; and
cutting the ribbon to the desired size to thereby form an optical polarizer.

2. The method according to claim 1, wherein the polarizing metal salt is selected from at least one of the group consisting of a non-fluorine halide of silver, copper and cadmium, including mixtures thereof.

3. The method according to claim 1, wherein the metal salt is a silver salt and the silver concentration is in the range of 0.05-1.0 wt. %

4. The method according to claim 1, wherein the polarizer is capable of polarizing light in a region selected from the group consisting of the visible, infrared and ultraviolet regions.

5. The method according to claim 1, wherein, before drawing, the glass is subjected to an etching step or a thermal treatment step, or both, to remove and/or heal surface defects.

6. The method according to claim 1, wherein after passing through the die, the glass is grabbed by a first set of rollers operating at a first rotational speed and after passing through the first set of rollers the glass is picked up by a second set of rollers operating at a second rotational speed that is greater then the first rotational speed, the difference between the two rotational speed being sufficient to pull and elongate the glass and particles therein to thereby provide a ribbon having the width or substantially the width of the glass as it was extruded from the die.

7. The method according to claim 1, wherein after passing through the die, the glass is grabbed by a single set of rollers operating at a rotational speed greater than the rate at which the glass is extruded from the die to thereby pull and elongate the glass and particles therein to provide a ribbon having the width or substantially the width of the glass as it was extruded from the die.

8. The method according to claim 1, wherein after passing through the die, the glass is grabbed by a movable gripper, the gripper moving at a rate sufficient to pull and elongate the glass and particles therein to provide a ribbon having the width or substantially the width of the glass as it was extruded from the die.

9. A method for making a silver-containing visible light glass polarizer, the method consisting of the steps:
melting a glass batch containing a source of silver and a halogen other than fluorine, and forming a glass body from a melt;
heat treating the glass body at a temperature above the glass strain point to generate halide crystals having a size in the range of 500-2000 Angstroms;
stressing the crystal-containing glass body at a temperature above the glass annealing point to elongate the body and thereby elongate and orient the crystals; and
exposing the elongated body to a reducing atmosphere at a temperature above 250° C. to develop a reduced surface layer on the body that contains metal particles with an aspect ration of at least 2:1;
wherein the stressing is carried out at a temperature above the annealing point of the glass using two sets of rollers, the glass being fed into a first set of rollers operating a first rotational speed and after passing through the first set of rollers the glass is picked up by a second set of rollers operating at a second rotational speed that is sufficiently greater than the first rotational speed so that sufficient is generated to elongate the silver particles.

10. A polarizer made according to claim 1, wherein said polarizer is capable of polarizing light in a region one selected from the group consisting of the visible, infrared and ultraviolet regions.

11. A silver containing polarizer according to claim 9, wherein the polarizer is capable of polarizing light in a region selected from the group consisting of the visible, infrared and ultraviolet regions, said polarizer having a silver content in the range of 0.5-1.0 wt. %.
